(19) United States
(12) Patent Application Publication
(10) Pub. No.: US 2014/0072844 A1
(43) Pub. Date: Mar. 13, 2014

(54) BATTERY SYSTEM

(71) Applicants: HYUNDAI MOTOR COMPANY, Seoul (KR); KIA MOTORS CORPORATION, Seoul (KR)

(72) Inventors: Man Ju Oh, Yongin (KR); Jae Woong Kim, Hwaseong (KR); Jae Woo Park, Ansan (KR)

(73) Assignees: KIA MOTORS CORPORATION, Seoul (KR); HYUNDAI MOTOR COMPANY, Seoul (KR)

(21) Appl. No.: 13/691,199

(22) Filed: Nov. 30, 2012

(30) Foreign Application Priority Data
Sep. 7, 2012 (KR) 10-2012-0099402

(51) Int. Cl. H01M 10/50

(52) U.S. Cl. CPC H01M 10/5067; H01M 10/5085
USPC 429/71

(57) ABSTRACT

Disclosed herein is a battery system, including: an airtight housing; a plurality of blowers disposed on a front portion and a rear portion of an interior of the airtight housing, respectively, the plurality of blowers configured to suction and discharge the air toward a middle of the airtight housing and discharge and suction the air to both sides of the airtight housing; a battery pack disposed between the plurality of blowers to form a plurality of rows wherein an air passageway traverses through a front portion and a rear portion of each row; a mixing section disposed between the plurality of rows in the middle of the airtight housing, is configured to mix air; and a thermoelectric element disposed on an air flow path on both sides of each blower.

### CROSS-REFERENCE

This application claims under 35 U.S.C. §119(a) the benefit of Korean Patent Application No. 10-2012-0099402 filed Sep. 7, 2012, the entire contents of which are incorporated herein by reference.

### BACKGROUND

(a) Field of the Invention

The present invention relates to a battery system, capable of improving efficiency of a battery used in a vehicle through cooling or heating of the battery.

(b) Description of the Related Art

Recently, efforts have been made in various industrial fields for replacing an internal combustion engine with an electrical engine to help solve environmental problems. Here, a battery serves as an alternative to fuel in the electrical engine and should maintain an optimal state of a fuel efficiency ratio or durability through increasing and decreasing a temperature of the battery used in the electrical vehicle and a hybrid vehicle.

Many conventional battery cooling and heating technologies are configured to suction air from an interior and an exterior of a vehicle and transfer the air to the battery for cooling the battery through air convection. In the prior configurations for simultaneously cooling and heating the battery, as described above, a plurality of battery packs and electrical devices may be disposed inside a battery housing. Thus, separate ducts may be disposed on a suction portion and a discharge portion for an air flow path for heat exchanging to be defined inside the battery pack and for air to flow therethrough.

Further, separate flow channels may be disposed on the exterior of the battery pack for the air flow path to be defined therein and thus, there are limitations to designing the battery system and efficiency of the cooling configuration for the battery may not be achieved.

For example, Korean Patent Application No. 10-2012-006927A, entitled, “A battery pack including radial fans,” relates to a battery pack including radial fans in which the radial fans are arranged such that the input and output direction of cooling air becomes perpendicular to the directions of the cooling air traversing through a plurality of battery cells to design a more efficient flow path of the cooling air. However, under this configuration of the battery pack, separate channels and ducts for the cooling air flow must be provided and thus, the cooling effect may decrease due to the substantially long cooling air flow.

The items described above are provided to help in understanding the background of the present invention, and shall not be construed to admit that they correspond to the technologies already known to those skilled in the art to which the present invention pertains.

### SUMMARY OF THE INVENTION

The present invention has been made in an effort to solve the above-described problems associated with prior art. An object of the present invention is to provide a battery system, capable of minimizing cooling air flow and decreasing the space required for heating and cooling the battery system components.

In one embodiment, the battery system includes: a substantially airtight housing; a plurality of blowers disposed on a front portion and a rear portion of an interior of the airtight housing, respectively, the plurality of blowers configured to suction and discharge air toward a substantially middle of the airtight housing and discharge and suction the air to both sides of the airtight housing; a battery pack disposed between the plurality of blowers to form a plurality of rows wherein an air passageway traverses through a front portion and a rear portion of each row may be formed; a mixing section configured to mix air may be formed between the plurality of rows disposed in the substantially middle of the airtight housing ; and a thermoelectric element may be disposed on an air flow path of both sides of each blower.

The plurality of blowers may be connected to the battery pack for suction and discharge of the air toward the substantially middle of the airtight housing through the air passageway of the battery pack and for discharge and suction of the air to both sides of the interior of the housing.

A substantially airtight guide may be disposed between the plurality of blowers and the battery pack adjacent to an edge of each blower. Furthermore, ventilation openings may be formed on the openings of the airtight guide, respectively, for the plurality of blowers to suction and discharge air toward the substantially middle of the airtight housing through the air passageway of the battery pack and to discharge and suction the air to both sides of the airtight housing.

The battery pack may be spaced from the front portion or the rear portion of the airtight housing at a predetermined width substantially similar to that of the airtight guide. Additionally, the thermoelectric element may be disposed within that space, adjacent to the ventilation openings of the airtight guide, to cool or heat the discharged air. Furthermore, radiation fins may be disposed on the thermoelectric element wherein the directions of the radiation fins may be substantially the same as the discharged or suctioned air.

The ventilation openings disposed on both sides of the airtight guide may be offset vertically and the thermoelectric element may be disposed on an upper end or a lower end of the airtight housing, adjacent to the ventilation openings, and the radiation fins may be directed toward the interior of the housing.

Moreover, multiple battery packs may be disposed side by side or adjacent to each other to form the plurality of rows therebetween and the battery pack may thus be substantially near the interior surface of the upper end and the lower end of the airtight housing. Additionally, in this arrangement of multiple battery packs, a diaphragm extending toward a side of each blower may be formed between the plurality of rows so the air discharged or suctioned from the plurality of blowers may be distributed substantially evenly to the respective battery packs.

Furthermore, a plurality of horizontal air passageways having a predetermined width may be disposed within the battery packs. The battery pack may be comprised of a plurality of vertically overlapping battery cells. The plurality of air passageways may be formed by grooves disposed on an upper and a lower surface of the overlapping battery cells.

In addition, the plurality of blowers may be disposed on a substantially middle of the front portion and the rear portion of the airtight housing, respectively, and the thermoelectric element may be disposed on an air flow path of both sides of the plurality of blowers.

### BRIEF DESCRIPTION OF THE DRAWINGS

The above and other features, objects and advantages of the present invention will be more clearly understood from the following detailed description taken in conjunction with the accompanying drawings which are given hereinbelow by way of illustration only, and thus are not limitative of the present invention, and wherein:

FIG. 1 is an exemplary view illustrating a battery system according to an exemplary embodiment of the present invention;

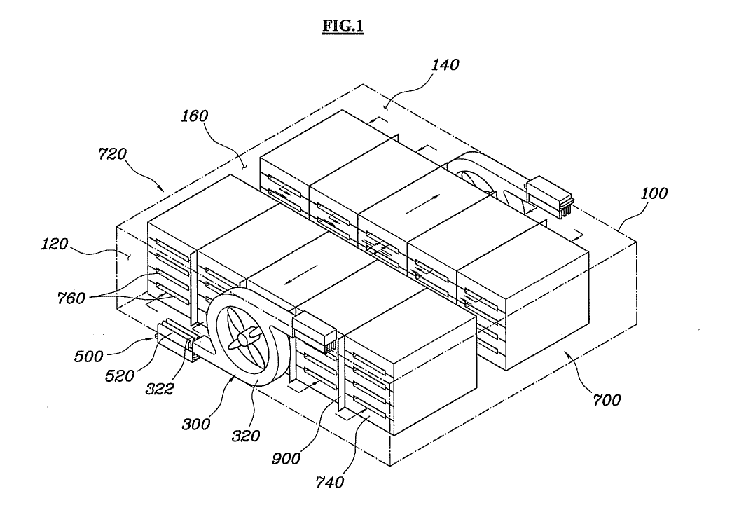

FIG. 2 is an exemplary sectional view from a horizontal direction illustrating a battery system according to an exemplary embodiment of the present invention; and

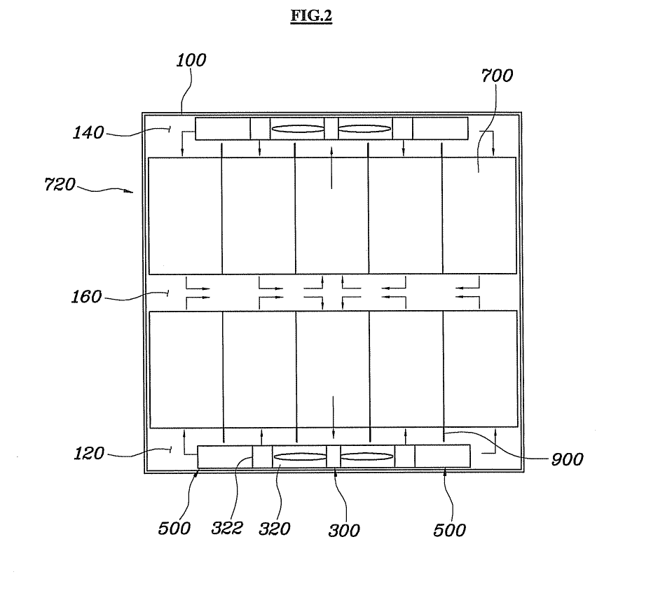

FIG. 3 is an exemplary sectional view from a vertical direction illustrating a battery system according to an exemplary embodiment of the present invention.

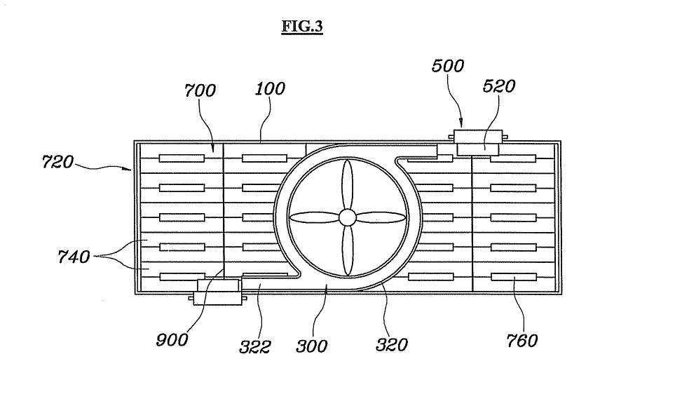

It should be understood that the accompanying drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a battery system for a vehicle according to an exemplary embodiment of the present invention will be described with reference to the accompanying drawings.

A battery system according to an embodiment of the present invention includes: a substantially airtight housing 100; a plurality of blowers 300 disposed on a front portion and a rear portion of the interior of the airtight housing, respectively, the plurality of blowers configured to suction and discharge air toward a substantially middle of the airtight housing and discharge and suction the air to both sides of the airtight housing; a battery pack 700 disposed between the plurality of blowers 300 to form a plurality of rows 720 wherein an air passageway 760 which traverses through a front portion and a rear portion of each row may be formed, a mixing section 160 configured to mix air may be formed between the plurality of rows 720 disposed in the substantially middle of the airtight housing 100; and a thermoelectric element 500 may be disposed on an air flow path of both sides of each blower 300.

The battery system according to the present invention may include the substantially airtight housing 100 eliminating external air from being input and output. Moreover, a portion of air in the interior of the housing may leak out of the airtight housing due to manufacturing error; however, the battery may be cooled or heated by using only the air in the interior thereby minimizing heat output and increasing energy efficiency.

The plurality of blowers 300 may be disposed on a front portion and a rear portion of the interior of the housing 100, respectively. Each blower 300 suctions air toward a substantially middle of the airtight housing and then discharges the air to both sides of the airtight housing, or suctions air toward both sides of the airtight housing and discharges the air to the substantially middle of the airtight housing. However, since the flow resistance may be substantially small and overload on each blower may be decreased when air is discharged toward both sides of the interior of the housing, each blower may suction air toward the substantially middle of the interior of the housing through the battery pack and then discharge the air to the spaces on the housing sides. Hereinafter, the embodiment in which the plurality of blowers suction air toward the substantially middle of the interior of the housing and then discharge the air toward both sides thereof will be described.

In this embodiment, there may be a plurality of four-way air flows in the interior of the airtight housing 100 through each blower 300 in the front portion and rear portion of the airtight housing, in other words, the air flows through the front, rear and sides of the interior of the airtight housing.

Moreover, the thermoelectric element 500 may be disposed on a discharging side of each blower 300. The thermoelectric element 500 may be disposed inside the airtight housing 100 wherein the thermoelectric element may receive electric energy and exchange heat, and may cool the interior of the airtight housing 100. In other words, the thermoelectric element 500 may be disposed on a discharging side of each blower 300 and may cool or heat the interior air of the airtight housing 100 while the interior air circulates.

Moreover, the plurality of blowers 300 may be substantially near the battery pack 700 so the plurality of blowers 300 suction air toward the substantially middle of the interior of the airtight housing through the air passageway 760 of the battery pack 700 and discharge the air to both sides of the airtight housing. In other words, a substantially airtight guide 320 may be disposed between each blower 300 and the adjacent battery pack 700 on the edges of each blower 300. In addition, the ventilation openings 322 may be formed on the openings of the airtight guide 320, respectively. Specifically, the fans of the plurality of blowers 300 may rotate on an interior portion of the substantially airtight guide 320 and suction air toward the substantially middle of the airtight housing through the air passageway 760 of the battery pack 700 and discharge the air through the ventilation openings 322 on both sides of the airtight housing. In this configuration, the air suction and the air discharging may be separated to accelerate air flow, in other words, to increase cooling or heating efficiency by separating airs having different temperatures and cooling substantially evenly the respective battery packs 700.

Further, the battery pack 700 may be spaced 120, 140 from the front portion or the rear portion of the airtight housing 100 at a predetermined width substantially similar to that of the airtight guide 320. Additionally, the thermoelectric element 500 may be disposed within the spaces 120, 140, adjacent to each ventilation opening 322 of the airtight guide 320, to cool or heat the discharged air. Furthermore, radiation fins 520 may disposed on the thermoelectric element 500 wherein the direction of the radiation fins 520 may be substantially the same as the discharged air.

In this embodiment, the air of the interior of the housing 100 may be cooled or heated in the respective spaces 120, 140, may be supplied to the battery pack 700 and then mixed in the mixing section 160 in the substantially middle of the interior of the airtight housing. Accordingly, separate ducts or channels may be omitted, though the battery system occupies narrow space in the housing 100.

In particular, the ventilation openings 322 may be disposed on each opening of the airtight guide 320 which may offset vertically. Furthermore, the thermoelectric element 500 may be disposed on an upper end or a lower end of the airtight housing 100, adjacent to the ventilation openings 322, and the radiation fins 520 may be directed toward the interior portion of the airtight housing 100 so a discharging resistance of the plurality of blowers 300 may be minimized to promptly cool the system and to increase the cooling or heating efficiency.

Moreover, multiple battery packs 700 may be disposed side by side or adjacent to each other to form a row 720 therebetween and the battery pack may thus be near an interior surface of the upper end and the lower end of the airtight housing 100 for the air to be circulated through the battery pack 700 to rapidly transfer heat without a separate channel. Additionally, in this arrangement of multiple battery packs 700 a diaphragm 900 extending toward a side of each blower 300 may be formed between the battery packs 700 so the air discharged from the plurality of blowers 300 may be distributed substantially evenly to the respective battery packs 700.

In other words, the air discharged from the discharging side of each blower 300 may be distributed uniformly to the respective battery packs 700 and thus the diaphragm 900 extending to a side of each blower 300 may be disposed between the battery packs 700 so the cooled air may remain on the respective battery packs for a longer period of time, thereby resulting in a substantially constant air suction between the diaphragm 900 to the respective battery packs 700 through the suction force of the plurality of blowers 300. When no diaphragm 900 is used, the variable amount of air may be distributed to the respective battery packs 700.

Additionally, the plurality of horizontal passageways 760 having a predetermined width may be disposed vertically within the respective battery packs 700 to uniformly cool the system. The battery pack 700 may be comprised of a plurality of vertically overlapping the battery cells 720 wherein the air passageway 760 may be formed by grooves formed on the upper and the lower surfaces of the overlapping battery cells 720, respectively. In other words, when a groove is formed on the upper and the lower surfaces of the respective battery cells 720, the air passageway 760 may be formed by the grooves when the battery cells 720 overlap. Further, as described above, the battery pack 700 may be disposed near an upper and a lower inner wall to form an integral channel.

According to the battery system as configured above, separate flow ducts or channels may not be necessary in the battery housing to decrease space for cooling and heating and the number of the components. Further, the cooling efficiency decrease may be prevented by achieving minimum cooling air flow.

While the present invention has been illustrated and described with reference to specific embodiments, it should be apparent to those skilled in the art to which the present invention pertains that the present invention may be variously improved and changed without departing from the scope of the present invention.

What is claimed is:

1. A battery system, comprising:
an airtight housing;
a plurality of blowers disposed on a front portion and a rear portion of an interior of the airtight housing, respectively, the plurality of blowers configured to suction and discharge air toward a middle of the airtight housing and discharge and suction the air toward both sides of the airtight housing;
a battery pack disposed between the plurality of blowers to form a plurality of rows, wherein an air passageway traverses through a front portion and a rear portion of each row;
a mixing section disposed between the plurality of rows in the middle of the airtight housing, is configured to mix the air; and
a thermoelectric element disposed on an air flow path on both sides of each blower.

2. The battery system of claim 1, wherein each blower is disposed near the battery pack for the plurality of blowers to suction and to discharge the air toward the middle of the airtight housing through the air passageway of the battery pack and to discharge and to suction the air to both sides of the airtight housing.

3. The battery system of claim 1, further comprising:
an airtight guide disposed between the plurality of blowers and the battery pack adjacent to an edge of each blower; and
a plurality of ventilation openings formed on both sides of the airtight guide, respectively, for each blower to suction and to discharge the air toward the middle of the airtight housing through the air passageway of the battery pack and to discharge and to suction the air to both sides of the airtight housing.

4. The battery system of claim 3, wherein the battery pack is spaced from the front portion or the rear portion of the airtight housing at a predetermined width.

5. The battery system of claim 4, wherein the thermoelectric element disposed between the battery pack and the front portion or the rear portion of the airtight housing, adjacent to the ventilation openings of the airtight guide, the thermoelectric element configured to cool or to heat the discharged air.

6. The battery system of claim 4, wherein a plurality of radiation fins are disposed on the thermoelectric element, wherein the directions of the plurality of radiation fins are the same as the discharged and suctioned air directions.

7. The battery system of claim 4, wherein the ventilation openings disposed on the sides of the airtight guide are offset vertically.

8. The battery system of claim 4, wherein the thermoelectric element is disposed on an upper end or a lower end of the airtight housing, adjacent to the ventilation openings.

9. The battery system of claim 4, wherein the radiation fins are directed toward the interior of the airtight housing.

10. The battery system of claim 1, wherein the battery pack is disposed adjacent to a second battery pack to form the plurality of rows and near a surface of an upper end and a lower end of the airtight housing.

11. The battery system of claim 1, further comprising a diaphragm extending toward a side of each blower between the plurality of rows, the diaphragm configured to evenly distribute the discharged and the suctioned air from each blower to the battery pack.

12. The battery system of claim 1, wherein a plurality horizontal air passageways having a predetermined width are disposed vertically in the battery pack.

13. The battery system of claim 12, further comprising a plurality of vertically overlapping battery cells, wherein the air passageway is formed by a plurality of grooves formed on an upper surface and a lower surface of the plurality of battery cells.

14. The battery system of claim 1, wherein the plurality of blowers are disposed in a middle of the front portion and the rear portion of the airtight housing.

15. The battery system of claim 1, wherein the thermoelectric element is disposed on the air flow path of both sides of each blower.
